(19) United States
(12) Patent Application Publication
(10) Pub. No.: US 2015/0077654 A1
(43) Pub. Date: Mar. 19, 2015

(54) TOUCH PANEL

(71) Applicants: Kuan-Yu Chu, Taichung City (TW); Yu-Ching Wang, Taichung City (TW); Yung-Hui Chang, Taichung City (TW); Chin-Pei Hwang, Taichung City (TW); Ming-Wu Chen, Nantou County (TW)

(72) Inventors: Kuan-Yu Chu, Taichung City (TW); Yu-Ching Wang, Taichung City (TW); Yung-Hui Chang, Taichung City (TW); Chin-Pei Hwang, Taichung City (TW); Ming-Wu Chen, Nantou County (TW)

(73) Assignee: WINTEK CORPORATION, Taichung City (TW)

(21) Appl. No.: 14/488,290

(22) Filed: Sep. 17, 2014

(30) Foreign Application Priority Data
Sep. 18, 2013 (TW) 102133957

(51) Int. Cl. G06F 1/16

(52) U.S. Cl. CPC G06F 1/169
USPC 349/12; 428/201

(57) ABSTRACT

A touch panel having a light transmitting area and a light shielding area adjacent to the light transmitting area is provided. The touch panel includes a cover plate, a first decoration layer, a touch-sensing element and a metal conductive layer. The first decoration layer is disposed on the cover plate and located in the light shielding area. The first decoration layer has at least one hollow area. The touch-sensing element is disposed on the cover plate and at least located in the light transmitting area. The metal conductive layer is disposed on the first decoration layer, located in the light shielding area and surrounds the touch-sensing element. A portion of the metal conductive layer surrounds the hollow area.

### CROSS-REFERENCE TO RELATED APPLICATION

This application claims the priority benefit of Taiwan application serial no. 102133957, filed on Sep. 18, 2013. The entirety of the above-mentioned patent application is hereby incorporated by reference herein and made a part of this specification.

### BACKGROUND OF THE INVENTION

1. Field of the Invention

The invention relates to a touch panel, and more particularly, to a touch panel that improves appearance and enhances visual effects.

2. Description of Related Art

Generally, a touch panel has to be installed on a surface of an electronic product for a user to input information by touching and to operate the electronic product. Or, a touch panel is integrated into a surface of a display panel so as to provide touching and displaying functions. Nonetheless, in order to shield locations of transmission lines and a layout of circuits, a border of a touch panel is usually disposed with a light shielding material in a dark color, such as in black color. That is the reason why borders of electronic products are usually in black color which cannot satisfy a user's demand for a product appearance.

Furthermore, in contemporary electronic devices, signs of corporate brands or product models are often arranged on the electronic devices, which are used to show corporate images or product properties. In order to arrange a sign representing a corporate brand or a product model on a touch panel, the sign thereof must be formed directly on a cover plate by metal coating or ink printing, and then a light shielding layer and transmission lines are sequentially formed, wherein the light shielding layer is disposed between the sign and the transmission lines. However, a metal sign formed by metal coating increases manufacturing costs and complicates a process of manufacturing a touch panel. If an ink sign is formed by ink printing, glossiness of ink is inferior to glossiness of metal, and thereby overall quality of the touch panel is significantly sacrificed.

### SUMMARY OF THE INVENTION

The invention provides a touch panel, which satisfies a user's demand for a product appearance and can avoid increases on manufacturing costs.

A touch panel of the invention has a light transmitting area and a light shielding area adjacent to the light transmitting area. The touch panel includes a cover plate, a first decoration layer, a touch-sensing element and a metal conductive layer. The first decoration layer is disposed on the cover plate and located in the light shielding area. The first decoration layer has at least one hollow area. The touch-sensing element is disposed on the cover plate and at least located in the light transmitting area. The metal conductive layer is disposed on the first decoration layer, located in the light shielding area, and surrounds the touch-sensing element, wherein a portion of the metal conductive layer surrounds the hollow area.

In an embodiment of the invention, the touch panel further includes a second decoration layer at least overlapping the metal conductive layer and a portion of the first decoration layer, and extending to the cover plate.

In an embodiment of the invention, the hollow area defines a product trademark, a function symbol or a function hole.

In an embodiment of the invention, the function hole is a camera hole or a sensing hole.

In an embodiment of the invention, a portion of metal conductive layer covers a portion of the hollow area.

In an embodiment of the invention, the portion of metal conductive layer covers the hollow area.

In an embodiment of the invention, a material of the metal conductive layer includes aluminum (Al), copper (Cu), molybdenum (Mo), or a combination thereof.

In an embodiment of the invention, the metal conductive layer is connected to a ground potential.

In an embodiment of the invention, the portion of metal conductive layer is electrically connected to the metal conductive layer.

In an embodiment of the invention, at least a portion of the metal conductive layer is disposed on the cover plate.

In an embodiment of the invention, an orthographic projection area of the metal conductive layer on the cover plate is not completely overlapped with an orthographic projection area of the first decoration layer on the cover plate.

In an embodiment of the invention, an orthographic projection area of the metal conductive layer on the cover plate is not overlapped with an orthographic projection area of the first decoration layer on the cover plate.

In light of the above, since the metal conductive layer of the invention has metallic luster, the orthographic projection area of the metal conductive layer on the cover plate is not completely overlapped or not overlapped with orthographic projection area of the first decoration layer on the cover plate, so as to provide a touch panel having a metallic annular rim. Moreover, since the hollow area of the present embodiment is covered by the metal conductive layer for a product trademark or a function symbol defined by the hollow area having metallic luster, there is no need for extra processing steps to form desired colors for the product trademark or the function symbol, and increased manufacturing costs can be avoided.

Several exemplary embodiments accompanied with figures are described in detail below to further describe the invention in details.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the invention.

FIG. 1 illustrates a schematic bottom view of a touch panel according to an embodiment of the invention.

FIG. 2 illustrates a schematic cross-sectional view of FIG. 1 along the line I-I′.

FIGS. 3A to 3C illustrate a schematic bottom view and a schematic cross-sectional view of a hollow area of the touch panel depicted in FIG. 1.

FIG. 4 illustrates a schematic bottom view of a touch panel according to an embodiment of the invention.

FIG. 5 illustrates a schematic bottom view of a touch panel according to another embodiment of the invention.

### DESCRIPTION OF EMBODIMENTS

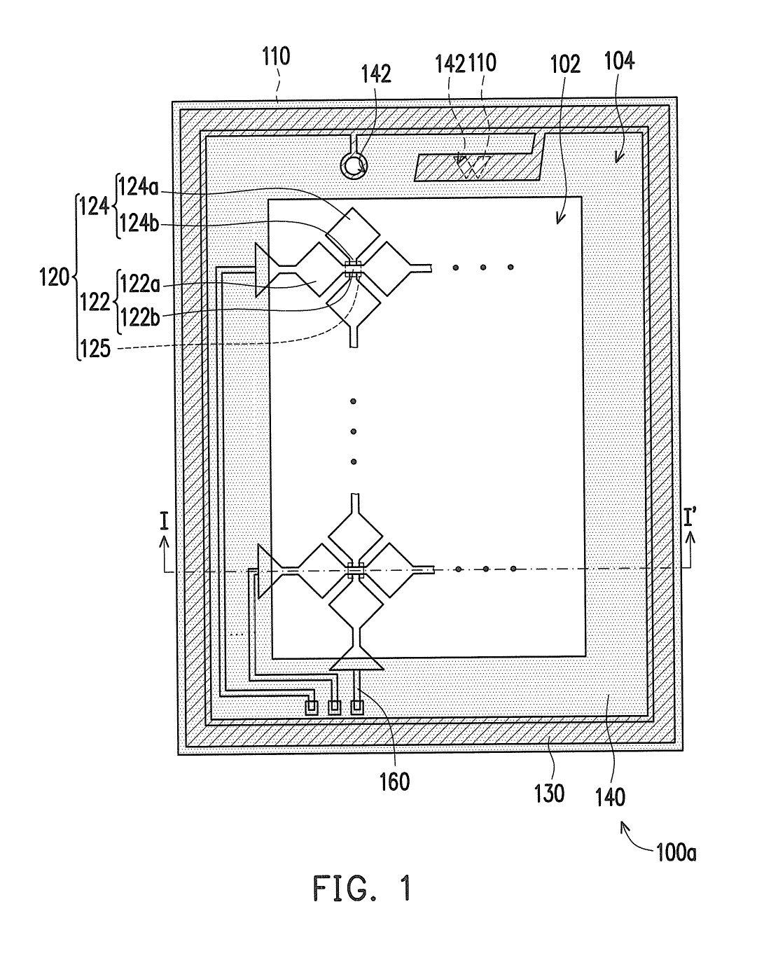

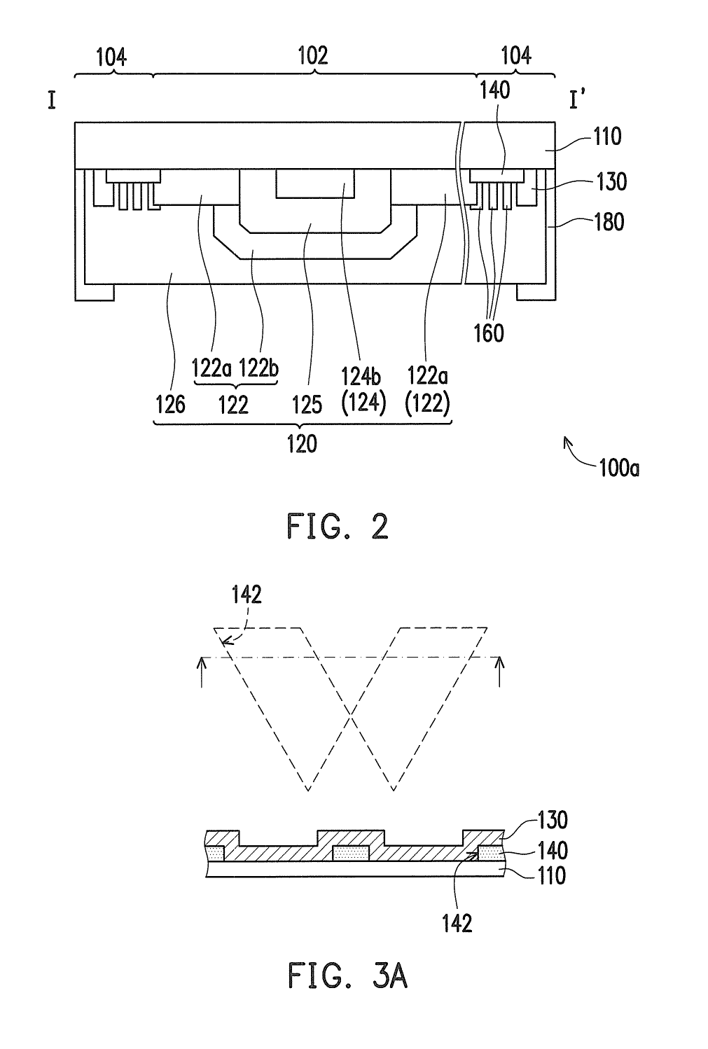

FIG. 1 illustrates a schematic bottom view of a touch panel according to an embodiment of the invention. FIG. 2 illustrates a schematic cross-sectional view of FIG. 1 along the line I-I′. Referring to FIG. 1 and FIG. 2, in the present embodiment, a touch panel 100a has a light transmitting area 102 and a light shielding area 104 surrounding the light transmitting area 102, wherein the light shielding area 104 is located at least one side of the light transmitting area 102. The touch panel 100a includes a cover plate 110, a touch-sensing element 120, a metal conductive layer 130 and a first decoration layer 140, wherein the metal conductive layer 130 is connected to a ground potential.

The touch-sensing element 120 is disposed on the cover plate 110 and at least located in the light transmitting area 102. At least a portion of the metal conductive layer 130 is disposed on the cover plate 110, located in the light shielding area 104 and surrounds the touch-sensing element 120. The first decoration layer 140 is disposed on the cover plate 110 and located in the light shielding area 104, wherein the first decoration layer 140 has at least one hollow area 142 exposing a portion of the cover plate 110 so as to define at least one pattern, such as a product trademark, a function symbol or a function hole. The function hole can be, for example, a cameral hole, a light source hole or a sensing hole. Namely, a camera lens, an LED light source, an infrared sensor or a charge-coupled device can be disposed behind the function hole, but the invention is not limited herein. When the hollow area 142 defines a product trademark, a portion of the metal conductive layer 130 covers the hollow area 142, and when the hollow area 142 defines a camera hole, a portion of the metal conductive layer 130 is disposed at an edge of the hollow area 142.

More particularly, the cover plate 110 of the present embodiment, for example, is a glass plate or a plastic plate. However, the invention is not limited herein. The touch-sensing element 120, for example, is consisted of a plurality of first electrode series 122 and a plurality of second electrode series 124. Each of the first electrode series 122 includes a plurality of first electrodes 122a and a plurality of first connecting lines 122b connecting the first electrodes 122a along one direction. Each of the second electrode series 124 includes a plurality of second electrodes 124a and a plurality of second connecting lines 124b connecting the second electrodes 124a along one direction. To avoid short circuit of the first electrode series 122 and the second electrode series 124, an insulation pattern 125 between the first connecting line 122b and the second connecting line 124b is further arranged. In addition, the touch sensing-element 120 further includes a passivation layer 126 covering the first electrode series 122 and the second electrode series 124.

As shown in FIG. 2, the first electrodes 122a and the second electrode series 124 of the present embodiment can be made of the same transparent conductive material. Next, the insulation pattern 125 is formed on the second connecting line 124b. Thereafter, the first connecting line 122b is formed on the insulation pattern 125. Now, the first connecting line 122b is disposed on one side of the insulation layer 125 far away from the cover plate 110, and can be made of a transparent conductive material or a metal material. However, the invention is not limited herein. In other embodiments not illustrated herein, the first connecting line 122b can firstly be formed on the cover plate 110 before fabricating the first electrodes 122a and the second electrode series 124, and the insulation pattern 125 is formed on the first connecting line 122b, and then the first electrode 122a and the second electrode series 124 are fabricated on the cover plate 110. Now, the first connecting line 122b is disposed between the insulation layer 125 and the cover plate 110, and can be made of a transparent conductive material or a metal material. The aforesaid techniques still belongs to a technical means adoptable in the invention and falls within the protection scope of the invention.

Furthermore, in order to connect the first electrode series 122 and the second electrode series 124 to a driving circuit or an external circuit, the touch panel 100a further includes a plurality of transmission lines 160, wherein the transmission lines 160 are disposed on the first decoration layer 140, located in the light shielding area 104 and electrically connected to the touch-sensing element 120. As shown in FIG. 2, the first electrode 122a extends to the first decoration layer 140 and covers a portion of the first decoration layer 140, while the transmission line 160 covers the first electrode 122a to form a connection. As a result, the first decoration layer 140 can shield the transmission lines 160 to provide an aesthetic appearance of the touch panel 100a.

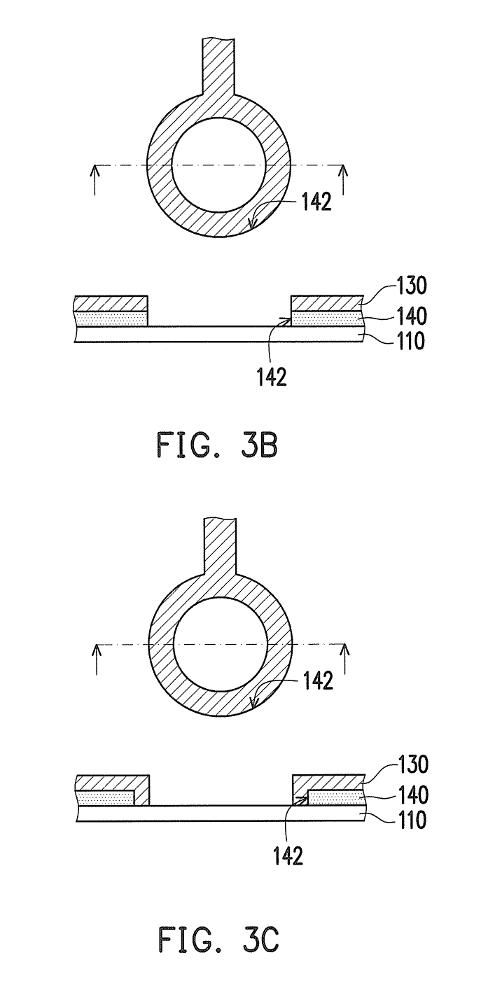

A material of the first decoration layer 140 of the present embodiment, for example, is an ink material or a photoresist material. More specifically, referring to FIG. 3A, when the hollow area 142 defines a product trademark, a portion of the metal conductive layer 130 is disposed within the hollow area 142 to cover a portion of the cover plate 110 exposed by the hollow area 142. Namely, when a user sees the touch panel 100a, colors of the metal conductive layer 130 is displayed on the cover plate 110 through the hollow area 142. As shown in FIG. 1, in the present embodiment, an area of the metal conductive layer 130 extending to the hollow area 142 is larger than an area of the hollow area 142. In other words, the metal conductive layer 130 covers the hollow area 142 and a portion of the first decoration layer 140. Moreover, the metal conductive layer 130 can be formed on the cover plate 110 by applying methods such as an evaporation method, a sputtering method, a screen printing method, a transfer printing method and a spraying method. A material of the metal conductive layer 130, for example, is a material having metallic luster such as aluminum (Al), copper (Cu), molybdenum (Mo), or a combination thereof.

Since the metal conductive layer 130 of the present embodiment has metallic luster, colors from the metal conductive layer 130 through the hollow area 142 and the first decoration layer 140 can be seen, such that a product trademark or a function symbol defined by the hollow area 142 on the touch panel 100a has metallic luster and the appearance quality is enhanced. Therefore, the touch panel 100a of the present embodiment can satisfy the user's demand for a product configuration. In addition, since the hollow area 142 of the present embodiment is covered by the metal conductive layer 130, there is no need for extra processing steps to form desired colors for a product trademark or a function symbol, which can avoid the increment on manufacturing costs.

Furthermore, referring to FIG. 2 again, the touch panel 100a of the present embodiment can also further include a second decoration layer 180, wherein the second decoration layer 180 is disposed to at least overlap the metal conductive layer 130 and a portion of the first decoration layer 140, and extends to the cover plate 110. Therefore, an area not shielded by the first decoration layer 140 and the metal decoration layer 130 on the light shielding area 104 is covered by the second decoration layer 180 to prevent light from leaking from the edge of the cover plate 110. The passivation layer 126 is disposed between the second decoration layer 180 and the metal conductive layer 130 and the first decoration layer 140.

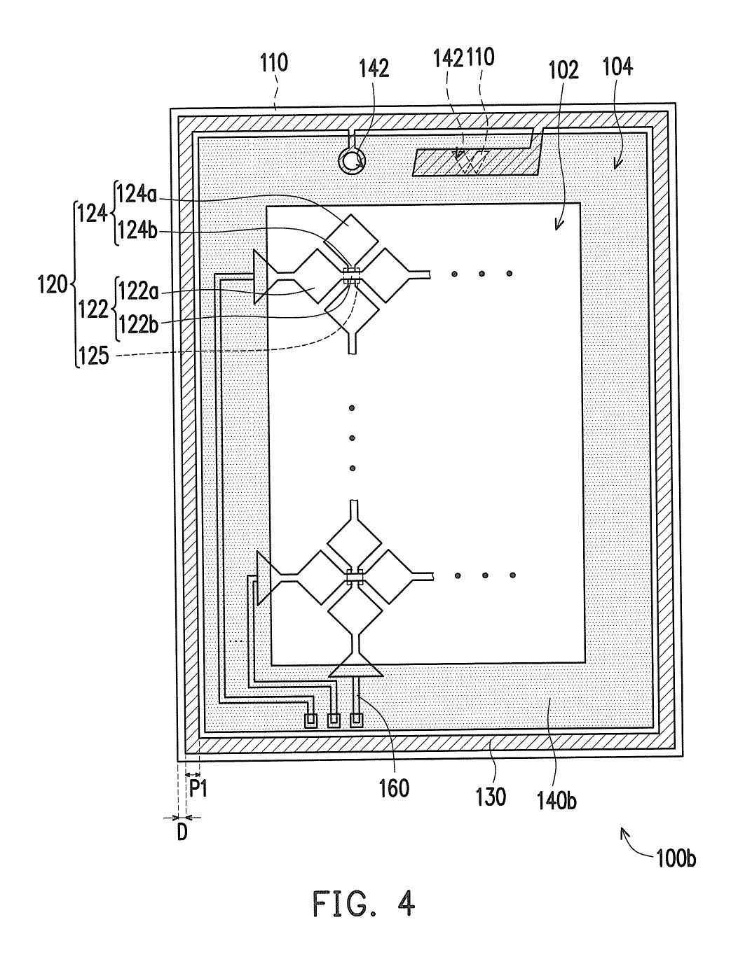

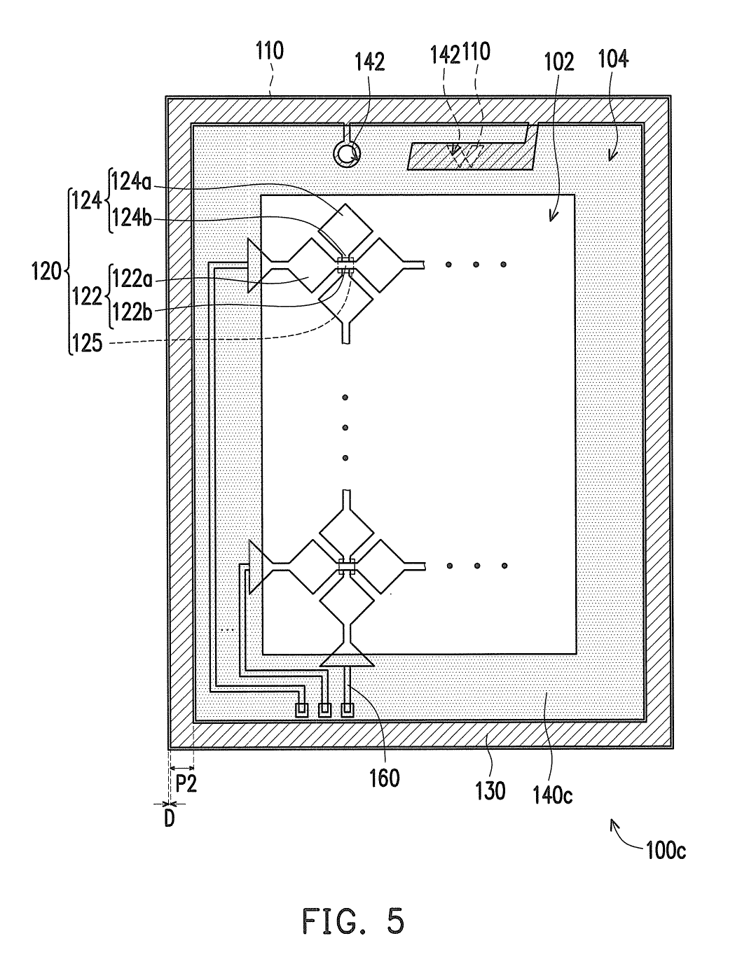

It should be noted that positioning methods and structural types of the metal conductive layer 130 of the invention is not limited herein. As shown in FIG. 3A, the metal conductive layer 130 of the present embodiment is disposed on one side of the first decoration layer 140 far away from the cover plate 110 and extends to the cover plate 110. In other embodiments, referring to FIG. 4, the metal conductive layer 130 of a touch panel 100b is disposed on the cover plate 110, and an orthographic projection area of the metal conductive layer 130 on the cover plate 110 is not overlapped with an orthographic projection area of a first decoration layer 140b on the cover plate 110; or, referring to FIG. 5, the metal conductive layer 130 of a touch panel 100c is disposed on the cover plate 110, and an orthographic projection area of the metal conductive layer 130 on the cover plate 110 is not overlapped with an orthographic projection area of a first decoration layer 140c on the cover plate 110, and a line width P2 of the metal conductive layer 130 in FIG. 5 is wider than a line width P1 of the metal conductive layer 130 in FIG. 4. Since the metal conductive layer 130 is connected to a ground potential and an area of the metal conductive layer 130 is proportional to anti-electrostatic capability, the touch panel 100c has better anti-electrostatic capability than the touch panel 100b. Here, the line widths P1 and P2 of the metal conductive layer 130 are at least 200 micrometers, and a distance D from an edge of the metal conductive layer 130 to an edge of the cover plate 110 is, for example, at least 100 micrometers.

Since orthographic projection areas of the metal conductive layer 130 on the cover plate of the touch panels 100a, 100b and 100c are not completely overlapped or not overlapped with orthographic projection areas of the first decoration layers 140, 140b and 140c on the cover plate 110, so as to provide the touch panels 100a, 100b and 100c having metallic annular rims. Moreover, since the hollow area 142 of the present embodiment is covered by the metal conductive layer 130, a product trademark or a function symbol defined by the hollow area 142 has metallic luster. Therefore, there is no need for extra processing steps to form desired colors for the product trademark or the function symbol, and increment on manufacturing costs can be avoided.

In addition, referring to FIGS. 1, 4 and 5, a cameral hole can be defined by the hollow area 142, and surrounded by the metal conductive layer 130 such that the grounded metal conductive layer 130 is configured to prevent external electrostatic from destroying internal devices through the hollow area 142. Referring to FIG. 3B, the metal conductive layer 130 covers the first decoration layer 140 and exposes a camera hole (i.e., a location at which the hollow area 142 is positioned); or, in other embodiments, referring to FIG. 3C, a portion of the metal conductive layer 130 extends to the cover plate 110 inside the camera hole, so as to provide the camera hole having a pattern of metal ring.

In summary, since the metal conductive layer of the invention has metallic luster, a touch panel having a metallic annular rim can be provided by the metal conductive layer disposed on the cover plate. Further, the metal conductive layer covers the hollow area defining a product trademark or a function symbol to provide metallic luster on the product trademark or the function symbol. Moreover, the grounded metal conductive layer surrounds the hollow area defining a camera hole and partially overlaps with the cover plate to provide the camera hole having a pattern of metal ring and to prevent external electrostatic from destroying internal devices through the hollow area. Therefore, the touch panel of the invention can satisfy a user's demand for a product appearance and electrical requirement. Additionally, since the invention is a design that provides various kinds of visual effects through the metal conductive layer, there is no need for extra processing steps to add metallic luster, and increased manufacturing cost can be avoided.

It will be apparent to those skilled in the art that various modifications and variations can be made to the structure of the disclosed embodiments without departing from the scope or spirit of the invention. In view of the foregoing, it is intended that the disclosure cover modifications and variations of this specification provided they fall within the scope of the following claims and their equivalents.

What is claimed is:

1. A touch panel, having a light transmitting area and a light shielding area adjacent to the light transmitting area, the touch panel comprising:
a cover plate;
a first decoration layer, disposed on the cover plate and located in the light shielding area, and having at least one hollow area;
a touch-sensing element, disposed on the cover plate and at least located in the light transmitting area; and
a metal conductive layer, disposed on the first decoration layer, located in the light shielding area and surrounding the touch-sensing element, wherein a portion of the metal conductive layer surrounds the hollow area.

2. The touch panel as claimed in claim 1, further comprising a second decoration layer, at least overlapping the metal conductive layer and a portion of the first decoration layer, and extending to the cover plate.

3. The touch panel as claimed in claim 1, wherein the hollow area defines a product trademark, a function symbol or a function hole.

4. The touch panel as claimed in claim 3, wherein the function hole is a camera hole or a sensing hole.

5. The touch panel as claimed in claim 1, wherein a portion of the metal conductive layer covers a portion of the hollow area.

6. The touch panel as claimed in claim 1, wherein a portion of the metal conductive layer covers the hollow area.

7. The touch panel as claimed in claim 1, wherein a material of the metal conductive layer comprises aluminum (Al), copper (Cu), molybdenum (Mo), or a combination thereof.

8. The touch panel as claimed in claim 1, wherein the metal conductive layer is connected to a ground potential.

9. The touch panel as claimed in claim 8, wherein the portion of metal conductive layer is electrically connected to the metal conductive layer.

10. The touch panel as claimed in claim 1, wherein at least a portion of the metal conductive layer is disposed on the cover plate.

11. The touch panel as claimed in claim 10, wherein an orthographic projection area of the metal conductive layer on the cover plate is not completely overlapped with an orthographic projection area of the first decoration layer on the cover plate.

12. The touch panel as claimed in claim 10, wherein an orthographic projection area of the metal conductive layer on the cover plate is not overlapped with an orthographic projection area of the first decoration layer on the cover plate.

13. A cover plate, having a light transmitting area and a light shielding area adjacent to the light transmitting area, the cover plate comprising:
a substrate;
a first decoration layer, disposed on the substrate and located in the light shielding area, and having at least one hollow area; and
a metal conductive layer, disposed on the first decoration layer, located in the light shielding area, wherein a portion of the metal conductive layer surrounds the hollow area.
